(19) United States
(12) Patent Application Publication
(10) Pub. No.: US 2026/0357978 A1
(43) Pub. Date: Nov. 12, 2026

(54) Suspendable light fixture

(71) Applicant: H4X e.U., Graz (AT)

(72) Inventor: Andreas HIERZER, Graz (AT)

(73) Assignee: H4X e.U., Graz (AT)

(21) Appl. No.: 19/670,493

(22) Filed: May 7, 2026

(30) Foreign Application Priority Data
May 8, 2025 (AT) A50312/2025

(51) Int. Cl. F21V 23/06; F21S 8/06; F21V 15/01; F21V 19/00; F21V 23/00; F21V 23/02; F21Y 105/16; F21Y 115/10

(52) U.S. Cl. CPC F21V 23/06; F21S 8/061; F21V 15/01; F21V 19/004; F21V 23/001; F21V 23/023; F21Y 2105/16; F21Y 2115/10

(57) ABSTRACT

A suspendable light fixture includes a light-supply circuit board, an inner housing which contains an optical component, an outer housing having an interior region, which is delimited in regions by side walls and by a connecting wall, for receiving the light-supply circuit board and receiving the inner housing. A separate contacting component is joined to the outer housing in the region of the connecting wall and is supported between the outer housing and the light-supply circuit board. First contact elements are distributed over a contacting area in the region of a main surface of the light-supply circuit board. The contacting component has second contact elements. During assembly, the first and second contact elements can be resiliently brought into mutual electrically conductive contact. In the assembled state, a spring action holds the contact elements in contact. Wireless conductive connections are established between the contacting component and the light-supply circuit board.

### FIELD OF THE INVENTION

The invention relates to a suspendable light fixture.

### TECHNICAL BACKGROUND

Suspended light fixtures, for example those of a flat configuration, are in principle known. Known, individually suspended light fixtures are in many cases constructed from components or assemblies which are permanently installed together and/or wired together. These permanently installed and/or wired components and assemblies may for example be housings, electronic assemblies, fastening mechanisms, light sources, such as circuit boards populated with LEDs, or optical elements, such as reflectors, lenses and covers with optical diffusion properties.

In conventional suspended light fixtures, replacing individual components or assemblies non-destructively is impossible or extremely difficult or can only be done with considerable effort, for example with the help of special tools and/or by qualified professionals. If parts of the light fixture, such as LED assemblies, have reached the end of their service life or no longer function as intended for other reasons, for example because of damage, replacing these parts and reusing still undamaged components is difficult or impossible in conventional suspended light fixtures.

Furthermore, profile lighting systems are known which make it possible to select light inserts of different types, to combine them flexibly and modularly, to connect them to the system wirelessly and to replace them flexibly as needed, for example so as to vary the light-directing properties and lighting effects or so as to replace light inserts which have reached the end of their service life.

Profile lighting systems of this type can be used flexibly and have numerous advantages. However, for applications where only individual suspended light fixtures are desired or required, these profile lighting systems are often relatively complex and expensive. Furthermore, in known profile lighting systems, conductor tracks extending in rails are often provided, and these require corresponding installation space and can result in greater installation heights than may be desirable in some applications.

A highly flexible, modular rail lighting system with combinable lighting modules and spotlights is described for example in DE 10 2021 202 972 A1.

Against this background, it would be desirable to have access to a suspendable light fixture which has a high degree of modularity in its construction and in which assemblies or components can if necessary be replaced non-destructively and more easily than in conventional suspended light fixtures. Furthermore, it would be desirable to achieve this without excessive complexity in the construction and mounting of the light fixture, without excessive costs and with a compact, in particular flat, construction.

### SUMMARY OF THE INVENTION

Therefore, an object of the present invention is to propose an improved suspendable light fixture in which assemblies or components of the light fixture can more easily be replaced non-destructively.

This object is achieved by a suspendable light fixture having the features of claim 1.

A suspendable light fixture is proposed, comprising a light-supply circuit board provided with LED devices, an inner housing, an outer housing and a separate contacting component.

The inner housing contains at least one optical component for directing light which can be emitted by the LED devices or at least by a number of them, or the inner housing is formed at least in regions as an optical component for directing light which can be emitted by the LED devices or at least by a number of them.

The outer housing has an interior region, which is delimited in regions by side walls of the outer housing and by a connecting wall of said housing connecting said side walls, and which is formed to receive the light-supply circuit board and to receive the inner housing at least in portions.

The separate contacting component is connectable or connected to an external power supply path, at least for providing electric current for operating the LED devices. The contacting component is joined to the outer housing in the region of the connecting wall and is supported at least in portions between the outer housing and the light-supply circuit board.

The light-supply circuit board has a first contact means with first contact elements distributed across a contacting area in the region of a main surface of the light-supply circuit board. The contacting component has a second contact means with second contact elements.

The first and second contact means form a contacting device in such a way that respectively corresponding ones of the first and second contact elements can be resiliently brought into mutual electrically conductive contact during assembly of the light fixture, and, in the assembled state of the light fixture, a spring action holds the respectively corresponding ones of the first and second contact elements in contact in each case, so as to supply the light-supply circuit board with at least the electric current. The contacting device thus establishes wireless electrically conductive connections between the contacting component and the light-supply circuit board.

One idea of the present invention is to equip a suspendable light fixture with a separate contacting component which, after assembly of the light fixture, is supported at least in portions between the outer housing and the light-supply circuit board and makes wireless connections to the light-supply circuit board possible in a simple manner by means of reliable, resilient contacting.

The light-supply circuit board with the LED devices saves installation space and contributes to a flat configuration of the light fixture. The invention makes use of the flat space available on the main surface of the light-supply circuit board as a contacting area, and in combination with the use of LED devices this makes an even more compact configuration possible with a reduced installation height.

The contacting component provided as a separate component increases the modularity of the light fixture. The flat and compact construction of the light fixture is further improved by joining this contacting component and the outer housing in the region of the connecting wall. The joining and the support of the contacting component at least in portions between the outer housing and the light-supply circuit board save additional installation space and contribute to a defined and stable mechanical coupling between the contacting component and the outer housing. Furthermore, this joining in the region of the connecting wall and the stated type of support of the contacting component simplify handling and improve clarity during assembly, disassembly, and reassembly of the light fixture. The contact elements can be brought into contact with one another in a simple manner. The spring action ensures reliable electrical contact and can also compensate for unavoidable manufacturing tolerances.

The wireless nature of the electrical connections established via the contacting device allows greatly simplified disassembly of the light fixture to replace individual parts and thus greatly improved repair capacity of the light fixture. Furthermore, the wireless nature of the electrical connections also advantageously contributes to a further saving of installation space.

The light fixture proposed according to the invention thus offers a high degree of modularity and makes it possible to replace components thereof in a simple, non-destructive manner and in particular without tools or only using simple, commercially available tools.

The light fixture thus has a greatly improved repair capacity. Components which are damaged or have reached the end of their service life, such as the light-supply circuit board, can easily be replaced. It is also possible for example to replace the optical component(s) so as to change the lighting effect. Undamaged and functional components, such as a high-quality outer housing, can easily be reused. A high degree of reusability is therefore achieved.

In this way, the proposed light fixture is configured to save material and thus contributes to implementing lighting in a resource-saving, environmentally friendly and sustainable manner.

Advantageous configurations and developments of the invention will become apparent from the further, dependent claims and from the description with reference to the drawings.

In a development, after the outer housing and the contacting component are joined, the second contact means is accessible from the interior region of the outer housing. In this development, to bring about the electrically conductive contact in each case, the mutually corresponding ones of the first and second contact elements can in each case be pressed against one another counter to the spring action by inserting the inner housing into the interior region. The wireless electrical connections between the contacting component and the light-supply circuit board are thus very easily established when the inner and outer housings are joined. Likewise, the relevant disassembly and disconnection of the connections can be performed very easily and quickly.

In another development, before the outer housing and the contacting component are joined, the contacting component can be fixed at fastening positions adjacent to the contacting area on the main surface of the light-supply circuit board. In this development, to bring about the electrically conductive contact in each case, the mutually corresponding ones of the first and second contact elements can in each case be pressed against one another counter to the spring action when the contacting component is being fixed to the main surface of the light-supply circuit board. This development also makes it possible to establish the wireless electrical connections easily while simultaneously having the option for the user to make a deliberate intervention to release the fixing so as to break the electrical contact between the first and second contact elements. For example, this can be expedient so as to avoid accidentally touching these contact elements in some applications-for example if some of the contact elements carry currents or signals which do not themselves meet SELV (safe extra-low voltage) requirements.

In one configuration, the first contact elements are each arranged rigidly and the second contact elements are each formed resiliently movable. This makes an expedient and cost-effective construction of the contacting device possible.

In one configuration, all of the first and second contact elements of the contacting device comprise spring-loaded contact pins and rigidly arranged, flat contact regions respectively corresponding thereto. In particular, the first contact elements may each be configured as a flat, preferably substantially planar, contact region in the contacting area on the main surface of the light-supply circuit board, and the second contact elements may each be formed as or with a spring-loaded contact pin. Flat contact regions may expediently be implemented on a circuit board by means of planar conductor track portions, for example. The spring-loaded contact pins, by contrast, may be procured as robust, durable and high-quality components and, if necessary, provided in a tight arrangement so as to save space, and they make reliable electrical contact possible.

In a development, the contacting device is further formed to bring about, between the contacting component and the light-supply circuit board, at least one wireless, electrically conductive connection for transmitting a control signal and/or at least one wireless, electrically conductive connection for transmitting a sensor signal. This not only provides power to the LED devices for operating them, but also for example additionally provides control of the light output and/or provides a connection for external wired communication with a sensor accommodated in the light fixture.

In particular, the contacting device may comprise two, three, four, five, six, seven, eight or nine pairs of respectively corresponding ones of the first and second contact elements. In this way, it is possible to meet a wide range of requirements on the number of desired wireless electrical connections between the contacting component and the light-supply circuit board for a wide range of functionalities. However, other numbers of contacting elements are also possible.

In one configuration, it is provided that the separate contacting component has a contacting component circuit board, and the second contact elements are distributed in the region of a main surface of said circuit board and arranged so as to be respectively contactable by the first contact elements. In this configuration, it is in particular further provided that, in the assembled state of the light fixture, the light-supply circuit board and the contacting component circuit board are arranged substantially mutually parallel and more preferably substantially parallel to the connecting wall of the outer housing. The arrangement of the circuit boards mutually parallel and parallel to the connecting wall saves space. Furthermore, the second contact elements may be arranged on the contacting component circuit board so as to save installation space and contacted on said circuit board via conductor tracks. A contacting component circuit board of this type can be manufactured and populated expediently.

In a development, the contacting component has a housing-part-like carrier component with a receiving region for the contacting component circuit board, the contacting component circuit board being received in the receiving region and the receiving region having an open face through which the second contact means is accessible. The contacting component circuit board is thus accommodated so as to be protected from excessive mechanical stress and unwanted touching, and at the same time it is possible to establish the wireless electrical connections using the contacting device.

In a further configuration, the housing-part-like carrier component has a box-like main portion, within which the receiving region with the open face is formed, the housing-part-like carrier component being formed with an overhang at a rim of the main portion, said rim delimiting the open face of the receiving region, and the outer housing resting on the overhang of the housing-part-like carrier component after the outer housing and the contacting component are joined. The overhang may in particular be plate-like. In this configuration, it is preferably provided that the overhang is formed substantially surrounding the open face along its periphery and/or with a plurality of partial overhangs provided along its periphery. The overhang makes reliable mechanical load transfer possible from the outer housing to the carrier component, which can thus also absorb mechanical loads from the weight of the light fixture or a portion thereof. Furthermore, the overhang contributes to precise joining of the outer housing and the contacting component. Because the overhang surrounds the open face or the partial overhangs are provided along its periphery, uniform absorption of mechanical loads is made possible. Furthermore, with the plate-like configuration of the overhang, it does not require much installation space in its transverse direction.

In particular, the housing-part-like carrier component is formed flat at least in portions, and/or the main portion is formed with a substantially cuboid outer shape. The flat formation of the carrier component at least in portions facilitates accommodating the contacting component so as to save space. Furthermore, the cuboid outer shape makes advantageous joining possible in the region of the connecting wall if the outer housing is formed elongate, for example by orientating longitudinal directions of the outer housing and of the cuboid outer shape mutually parallel.

In one configuration, it is provided that the ratio of the width of the main portion to the thickness of the main portion is at least 2, preferably in a range of approximately 2.5 to approximately 4.5, more preferably in a range of approximately 3 to approximately 4. A main portion of this type saves space and simultaneously makes good accommodation of the contacting component circuit board possible, as well as reliable electrical connection of said circuit board to incoming or outgoing electrical conductors, for example clamping of the wires of a cable.

In a development, the connecting wall of the outer housing is provided with a clearance, which is in particular formed substantially rectangular. To join the contacting component to the outer housing, it is insertable into the clearance from the interior in portions. Preferably, after the joining, the contacting component substantially fills the clearance. In this way, the contacting component can be joined to the outer housing in a manner which particularly saves installation space. In particular, space is saved in a direction transverse to the connecting wall. The rectangular shape of the clearance is also advantageously adapted to an elongate shape of the outer housing and can interact well with a cuboid shape of the main portion of the carrier component, for example being filled by the main portion.

In one configuration, the contacting component can be latched to the outer housing when being joined thereto and is thus positively, and preferably detachably, held on the outer housing in the assembled state of the light fixture. In particular, in this configuration, the contacting component is provided with latching means for latching to the outer housing, which are configured to engage the connecting wall positively in portions from behind. Reliable yet easily releasable fastening of the contacting component to the outer housing is thus achieved, and in particular further facilitates assembly and disassembly of the light fixture.

The latching means of the contacting component may in particular be formed to engage the connecting wall positively in portions from behind, from an outer face of the connecting wall.

Furthermore, in another configuration, the latching means may be provided on opposite narrow faces of the housing-part-like carrier component. In particular for an elongate shape of the outer housing, the carrier component is thus held with the latching means, and at the same time maximum use is made of the carrier component for accommodating the second contact means and in particular the contacting component circuit board. Installation space available in the longitudinal direction both of the outer housing and of the carrier component can be made effective use of for the latching means, whereas this installation space is advantageously saved transverse to the longitudinal direction.

In particular, the light fixture is formed for suspension from a part of a building, in particular from a ceiling. A room region can thus be illuminated in a functional and aesthetically pleasing manner. Advantageous and sustainable lighting with limited costs and limited complexity is thus achieved, in particular for applications where planning and installing a complex profile lighting system would be prohibitively expensive. However, in variants, extensive lighting arrangements with a large number of the proposed suspendable light fixtures can also be implemented.

In one configuration, the contacting component is configured as part of a suspension device for the light fixture and is configured to absorb and transmit mechanical loads at least from part of the weight of the light fixture. Thus, in addition to its electrical function, the contacting component may also perform a mechanical function, and for example additional suspension components can thus be omitted.

In a development, an external operating device is provided, and the contacting component is connected to the external power supply path via the external operating device. In this development, a cable is provided which electrically conductively connects the second contact means to the external operating device. This eliminates the need for space within the light fixture for an operating device of this type, and this in turn contributes to the desired slim and aesthetically flat construction of the light fixture.

The external operating device may in particular be formed as an electronic ballast and be set up to convert a mains voltage supplied via the external power supply path into a rectified low voltage. The light-supply circuit board with the LED devices can thus be supplied with the required current type, voltage and current level.

In a development, the housing-part-like carrier component is formed with a strain relief for the cable.

In a further development, the external operating device is also formed with a strain relief for the cable.

Strain reliefs of this type prevent mechanical overloading of connections between the electrical conductors of the cable and corresponding conductive connecting components, such as terminals.

In one configuration, the inner housing carries the light-supply circuit board. In particular, the inner housing may carry the light-supply circuit board on a face of the inner housing facing the connecting wall. It is thus possible to avoid fastening the light-supply circuit board separately in the interior region of the outer housing.

In a further configuration, the light-supply circuit board is fastened to the inner housing by means of a latched or snap-in connection, preferably so as to be detachable non-destructively. This makes simple and reliable fastening of the light-supply circuit board possible. Furthermore, in this way an easy-to-handle unit comprising the inner housing and the light-supply circuit board is formed.

In a development, the inner housing can be mechanically coupled to the outer housing, preferably by latching, by inserting it into the interior region of the outer housing. In particular, in this development it is provided that the resulting mechanical fastening of the inner housing in the outer housing is releasable non-destructively. In this way, the inner housing can easily be fastened in the interior region and removed again as required.

In a development, the inner housing can be latched to the outer housing by inserting it into the interior region of the outer housing, the resulting latched connection between the inner housing and the outer housing being releasable non-destructively. A latched connection of this type also saves installation space, is cost-effective to manufacture and is easy to handle.

In one configuration, it is provided that the optical component is a first optical component for providing direct illumination, and the light fixture further has at least one second optical component for providing indirect illumination. In this configuration, the light-supply circuit board may be equipped with LED devices on both of its main surfaces. In particular, the outer housing may have at least one additional clearance so as to allow light emission via the second optical component. The possibility of indirect illumination expands the range of applications of the light fixture and contributes to an aesthetically pleasing and pleasant lighting effect. Because use is made of both main surfaces of the light-supply circuit board, a further circuit board or LED board is not required, and so additional contacting requirements, additional space requirements and additional costs can be avoided and assembly and disassembly are simplified.

In an alternative configuration, the outer housing may be translucent at least in part to provide indirect lighting, it being possible for the light-supply circuit board to be equipped with LED devices on both of its main surfaces. In this configuration, a second optical component for the indirect lighting may be provided or omitted.

In a development, the light fixture is formed elongate and/or linear. In particular, the ratio of the length of the outer housing to the width of the outer housing is in a range of approximately 15 to approximately 75, preferably in a range of approximately 20 to approximately 40. A light fixture of this type is for example well-suited to illuminating relatively elongate work areas, for example an office desk, or other elongate areas of various kinds.

In a further development, the outer housing is formed with a linear profile, and in particular it is provided that the profile has an inverted U-shaped cross section, the interior region being formed between the legs of the U. An outer housing of this type can expediently be manufactured by extrusion, for example, and makes it possible to provide the interior region in a simple and aesthetically pleasing manner.

In a further configuration, end faces of the linear profile of the outer housing may for example each be fitted with an end cover. Thus, the aesthetic appearance is further improved and unwanted access to internal components is better prevented.

In one configuration, it is provided that the ratio of the width of the outer housing to the thickness of the outer housing is at least approximately 2, preferably in a range of approximately 2 to approximately 4, more preferably in a range of approximately 2.5 to approximately 3.5. An outer housing of this type is comparatively flat, yet offers sufficient space for additional components.

In a further configuration, it is provided that the ratio of the width of the outer housing to the thickness of the outer housing is at least approximately 2, preferably in a range of approximately 2 to approximately 5, more preferably in a range of approximately 3 to approximately 4. An inner housing having dimensional ratios of this type is suitable in particular in cooperation with the outer housing described above.

In one configuration, the inner housing may be accommodated in the interior region substantially flush with the outer housing, but in another configuration it may for example protrude in part from the outer housing instead.

In further configurations, the light fixture may have a basic shape, in particular a flat one, which deviates from a linear and/or elongate shape. Light fixtures for other applications can thus be provided, and can easily be repaired or modified in a sustainable and resource-efficient manner by replacing individual components as required.

In a preferred configuration, the outer housing is made of or with a metal material, in particular of or with aluminium or an aluminium alloy. In particular if a material such as Al or an Al alloy is used for the outer housing, the ease of reuse means that significant savings can be made in resource and energy consumption and potentially associated CO₂ emissions and that the environment can be protected.

In one configuration, the inner housing may be a single piece and be configured in whole or in regions as the optical component. An inner housing of this type with an integrated optical component is particularly easy to handle and can be manufactured cost-effectively.

In another configuration, the inner housing is formed in multiple parts, with one optical component or a plurality of optical components and an inner housing fastening part, the optical component(s) being held by the inner housing fastening part. In this way, greater flexibility can be achieved as regards the optical components provided in the initial equipment and their potential replacement.

In one configuration, the inner housing, and/or the inner housing fastening part if provided, is made of a plastics material. An inner housing or inner housing fastening part of this type is lightweight and cost-effective to manufacture.

In yet further configurations, the optical component, or the first optical component and/or second optical component, are each made with a plastics material. Optical components of this type are lightweight and can also be manufactured at a reasonable cost.

The above configurations and developments can be combined with one another, within reason. Further possible configurations, developments and implementations of the invention also include combinations not explicitly mentioned of features of the invention which are described above or in the following with reference to the example embodiments. In particular, a person skilled in the art will also add individual aspects as improvements or additions to each basic form of the present invention.

### CONTENTS OF THE DRAWINGS

The invention is explained in greater detail in the following with reference to the example embodiments shown in the drawings, in which:

FIG. 1 shows a suspendable light fixture according to a first example embodiment, in perspective in an exploded view from a first side of the light fixture;

FIG. 2 shows an end portion of the light fixture of FIG. 1, in perspective in an exploded view from a second side of the light fixture, including first and second optical components;

FIG. 3 shows, in perspective, an end portion of an outer housing as well as a carrier component and a contacting component circuit board of a contacting component of the light fixture of FIG. 1, seen from the first side;

FIG. 4 shows the end portion of the outer housing, in a state where the contacting component is joined to the outer housing, in perspective from the second side, along with a portion of the second optical component, a portion of a cable and an external, opened operating device;

FIG. 5 shows a larger portion of the outer housing, comprising the end portion of FIGS. 3 and 4 and the contacting component circuit board for the joined state, in perspective from the first side, together with a portion of the second optical component;

FIG. 6 shows the situation of FIG. 5, a portion of the cable and a component of a strain relief additionally being shown;

FIG. 7 shows the situation of FIG. 6, the carrier component for the joined state of the contacting component and the outer housing additionally being shown;

FIG. 8 shows a portion of an inner housing, which is formed as the first optical component, and a light-supply circuit board carried by the inner housing, in perspective from the first side, along with some components of a contacting device;

FIG. 9 shows the situation of FIG. 7 without the cable, enlarged in detail;

FIG. 10 is a front view of the outer housing and inner housing, the light-supply circuit board and the second optical component in the assembled state, an end cap of the outer housing in the form of an end cover having been omitted;

FIG. 11 is a front view of the outer housing and inner housing, the light-supply circuit board, the contacting component circuit board and some components of the contacting device in the assembled state, an end cap of the outer housing having been omitted;

FIG. 12 is a perspective view of an end portion of an inner housing and an associated portion of a light-supply circuit board for a suspended light fixture according to a second example embodiment; and

FIG. 13 is a perspective view of an end portion of an inner housing and an associated portion of a light-supply circuit board for a suspended light fixture according to a third example embodiment.

The accompanying drawings are intended to provide a further understanding of the embodiments of the invention. They illustrate embodiments and serve, in conjunction with the description, to explain the principles and concepts of the invention. Other embodiments and many of the stated advantages will become apparent with reference to the drawings. The elements of the drawings are not necessarily shown to scale with one another.

In the drawings, unless stated otherwise, like, functionally equivalent and equivalently operating elements, features and components are provided with like reference signs in each case.

### DESCRIPTION OF EXAMPLE EMBODIMENTS

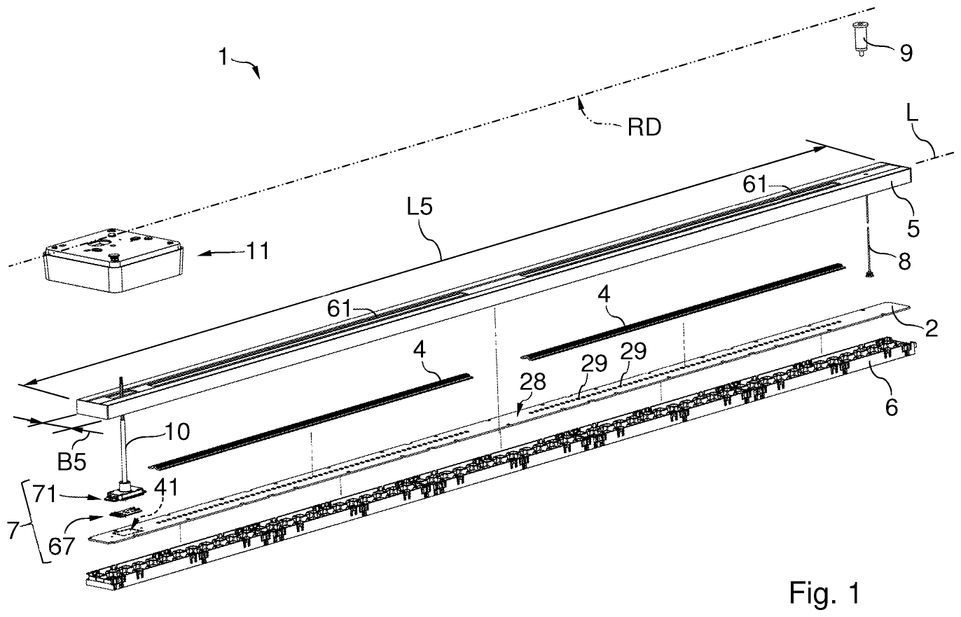

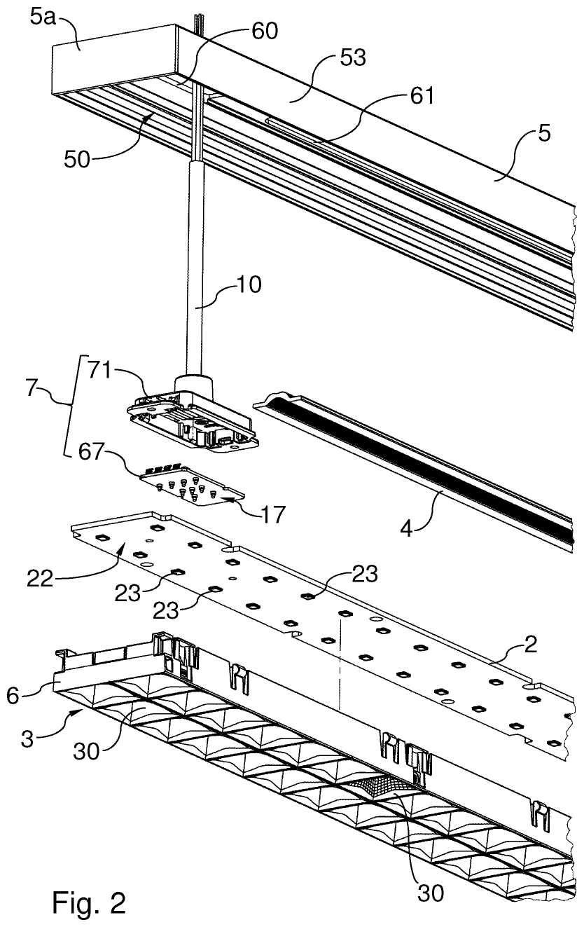

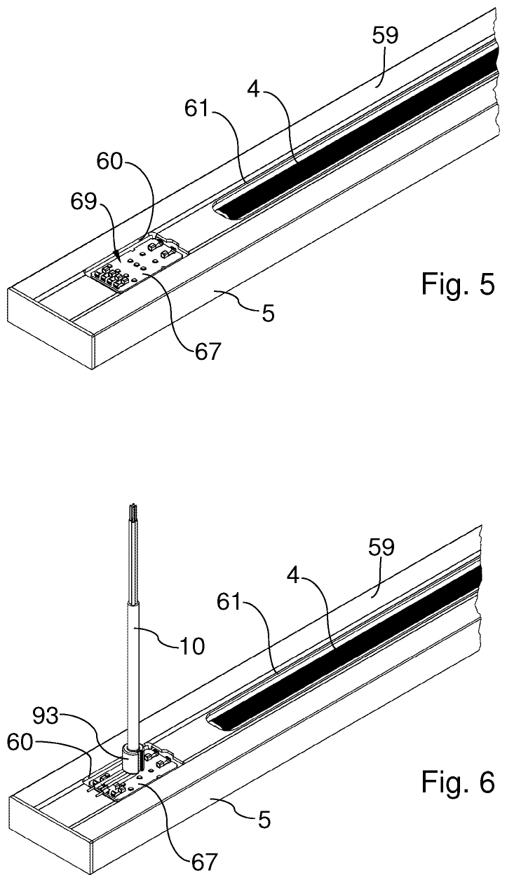

FIG. 1 shows a light fixture 1, formed suspendable, elongate, and linear, according to a first example embodiment, which is configured for suspension from a ceiling RD (only shown schematically in FIG. 1), preferably in the interior of a building. In a variant, the light fixture 1 could instead be suspended from another suitable part of building. FIGS. 2-11 illustrate details of the light fixture 1 according to the first example embodiment.

The light fixture 1 comprises an elongate outer housing 5 formed with a linear profile, the profile having an inverted U-shaped, downwardly open cross section when viewed in the suspended state of use of the light fixture 1. The profile of the outer housing 5 is made of a metal material, in particular aluminium or an aluminium alloy, for example by extrusion, and is closed at end faces of the outer housing 5 by means of end caps 5a, which may for example be made of a plastics material.

The light fixture 1 further comprises an elongate, straight-line or linear light-supply circuit board 2, an elongate and linear inner housing 6, which in the first example embodiment is formed in one piece as a first optical component 3, and second optical components 4.

The light-supply circuit board 2, formed as an LED board, is equipped with a large number of LED devices 23 and 29 and is populated on both sides. The LED devices 23 are for direct illumination and are arranged on a first main surface 22 of the light-supply circuit board 2 which is lower when the light fixture 1 is suspended, while the LED devices 29 are for indirect illumination and are arranged on a second main surface 28 of the light-supply circuit board 2 which is higher when the light fixture 1 is suspended.

In the light fixture 1, the first optical component 3 is provided to direct light emitted by the LED devices 23, for direct illumination, while the second optical components 4 are provided to direct light emitted by the LED devices 29 during operation, for indirect illumination. In the example embodiment sketched in FIGS. 1-11, the first optical component 3 is configured with reflector regions 30, which are each associated with one of the LED devices 23. The second optical components 4, by contrast, are each configured as an elongate lens in the example light fixture 1.

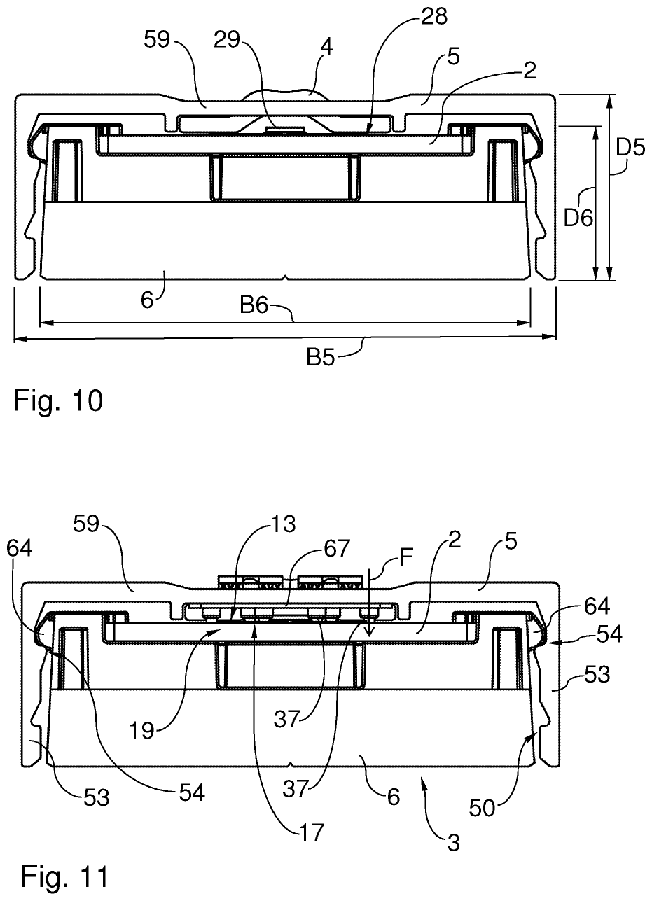

The outer housing 5 has mutually parallel side walls 53 extending along a longitudinal direction L thereof and a connecting wall 59 connecting the side walls 53, which together form the U shape of the profile cross section. Together, the side walls 53 and the connecting wall 59 delimit an interior region 50 of the outer housing 5 in regions. The interior region 50 thus formed between the U legs of the U shape of the profile is configured to receive the light-supply circuit board 2 and, at least in portions, the inner housing 6. In the first example embodiment (see for example FIGS. 10-11), the inner housing 6 is completely accommodated in the interior region 50, the light-supply circuit board 2 is arranged on the face of the inner housing 6 higher in FIGS. 10-11 and facing the connecting wall 59, and light is emitted during operation by means of the LED devices 23, directed by the first optical component 3 through a space formed between free ends of the side walls 53 into the room region to be illuminated.

In the light fixture 1, the ratio of the width B6 to the thickness D6 of the inner housing 6 is at least approximately 2 and is preferably in a range of approximately 2 to approximately 5, more preferably in a range of approximately 3 to approximately 4. By way of example, in the example embodiment illustrated in the drawings, B6/D6≈3.2.

In the first example embodiment, the ratio L5/B5of the length L5 of the outer housing 5 to the width B5 of the outer housing 5 is in a range of approximately 15 to approximately 75, preferably in a range of approximately 20 to approximately 40. Furthermore, in the light fixture 1 of the first example embodiment, the ratio B5/D5 of the width B5 of the outer housing 5 to the thickness D5 of the outer housing is at least approximately 2 and is preferably in a range of approximately 2 to approximately 4, more preferably in a range of approximately 2.5 to approximately 3.5. By way of example, in the light fixture 1 illustrated in FIG. 1, the length L5=1254 mm, the width B5=45 mm, and the thickness D5=15.4 mm. Thus, in this example configuration, L5/B5≈27.9 and B5/D5≈2.9. However, many other lengths, widths, thicknesses and ratios thereof are equally conceivable in relation to the outer housing 5.

The connecting wall 59 is provided with two elongate clearances 61 which extend along the longitudinal direction L and through each of which one of the second optical components 4 can pass in portions (see for example FIGS. 1, 9 and 10), so as to direct the light emitted by the LED devices 29 during operation, with a light distribution influenced by the second optical components 4, towards the ceiling RD so as to implement indirect lighting.

In its operational, assembled state, the light fixture 1 is supplied with electric current for operating the LED devices 23 and 29 and preferably with a control signal or control signals, for example based on the DALI protocol, via an external power supply path (not shown in detail in the drawings). In addition, in some variants of the first example embodiment, the light fixture 1 may also comprise a sensor or a plurality of sensors. In this case, sensor signals may be transmitted in a wired manner via an external path connected to the light fixture 1, as required.

In its operational state, the light fixture 1 is connected to the external power supply path by means of a separate contacting component 7 (“current tap”) and via an external operating device 11, so as to supply the light-supply circuit board 2 with at least an electric current for operating the LED devices 23 and 29. In the first example embodiment, the operating device 11 is formed as an electronic ballast and is set up to convert a mains voltage, supplied via the external power supply path, into a rectified low voltage. The electronic ballast provides a direct current, at the voltages and current levels required for operating the devices provided on the light-supply circuit board 2, in particular the LED devices 23 and 29. The contacting component 7 and its interaction with the outer housing 5, with the light-supply circuit board 2 and indirectly with the inner housing 6 are explained in greater detail below.

By way of a suspension device, the light fixture 1 is set up for suspension from the ceiling RD. Viewed along a longitudinal direction L of the outer housing 5—which, in the assembled state, corresponds to a longitudinal direction of the light fixture 1—the suspension device comprises, adjacent to a first one of the end portions of the light fixture 1, a rope 8, which at a lower end is positively suspended in the outer housing 5 and at an upper end is fastened to the ceiling RD by means of a fastening device 9. Furthermore, the suspension device comprises, at a second, opposite end portion of the light fixture 1 as seen in its longitudinal direction L, a cable 10, the external operating device 11 fastened to the ceiling RD and the separate contacting component 7, which is mechanically connected to the external operating device 11 via the cable 10. In this case, the contacting component 7 is thus configured as part of the suspension device for the light fixture 1 and can absorb mechanical loads resulting from at least part of the weight of the light fixture 1 and transmit them via the cable 10. However, in variants of the first example embodiment, a further rope 8 may alternatively be provided to support the light fixture 1 adjacent to its second end portion, and in variants of this type the cable 10 may then serve solely as an electrical connection, without absorbing mechanical loads from the weight of the light fixture 1.

The separate contacting component 7, which is formed relatively small and predominantly flat, has a housing-part-like, inverted trough-like carrier component 71, which is flat in portions, and a contacting component circuit board 67.

The carrier component 71 is formed for example as a single-piece cast, for example injection-moulded, component. The carrier component 71 comprises a box-like main portion 75 with a substantially cuboid outer shape. Within the main portion 75, a receiving region 73 with an open face 79 is formed, the receiving region 73 receiving the contacting component circuit board 67. Through the substantially rectangular, open face 79, a first main surface 68 of the contacting component circuit board 67 is substantially completely accessible, while a second main surface 69 of the contacting component circuit board 67, opposite the first main surface 68, is arranged concealed in the receiving region 73 by the carrier component 71.

In the first example embodiment, the ratio B75/D75 of the width B75 of the main portion 75 to the thickness D75 of the main portion 75 is at least 2. Preferably, B75/D75 is in a range of approximately 2.5 to approximately 4.5, more preferably in a range of approximately 3 to approximately 4. For the example configuration sketched in the drawings, B75/D75≈3.5, with B75≈20.5 mm and D75≈5.9 mm in the example shown.

The open face 79 is delimited by a peripheral rim 78 of the main portion 75. Two tab-like partial overhangs 88 and two strip-like partial overhangs 89 extend outwards from the rim 78. The partial overhangs 88 and 89 are formed in one piece with the main portion 75 and together form parts of a plate-like overhang 83 which substantially surrounds the open face 79 along its periphery 80. The partial overhangs 88 are arranged on mutually opposite narrow faces 97 of the carrier component 71, while the partial overhangs 89 are arranged on opposite long faces 98 of the carrier component 71.

In the assembled and operational state of the suspendable light fixture 1 (see for example FIGS. 10 and 11), the light-supply circuit board 2 is arranged between the inner housing 6 and the connecting wall 59, parallel to the connecting wall 59. In this state, the contacting component 7 is joined to the outer housing 5 in the region of the connecting wall 59.

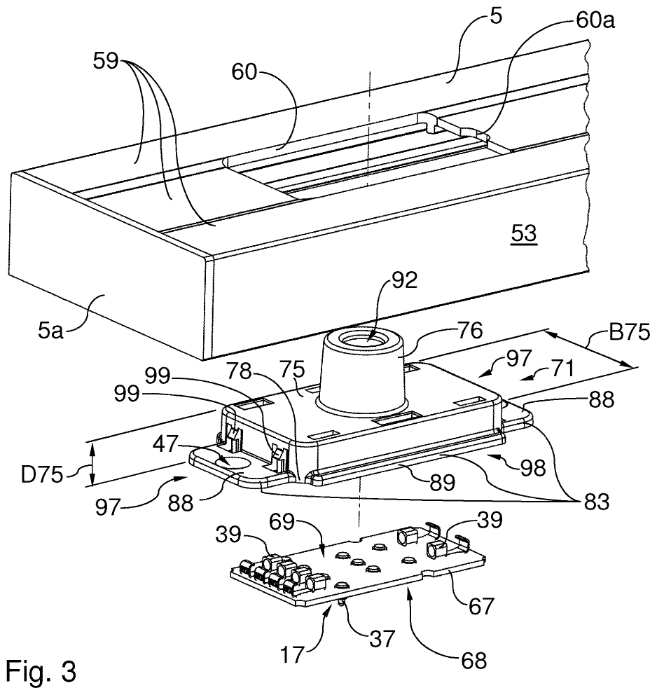

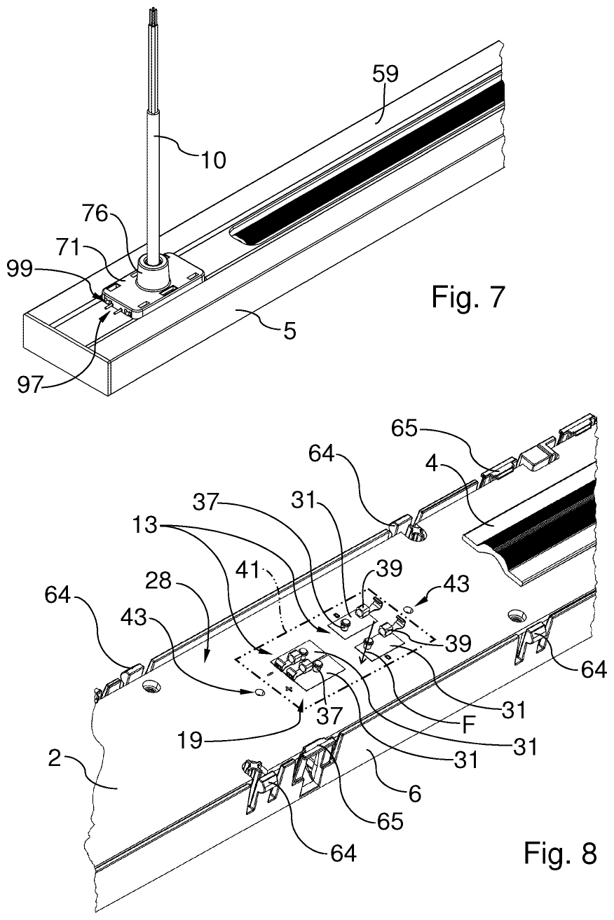

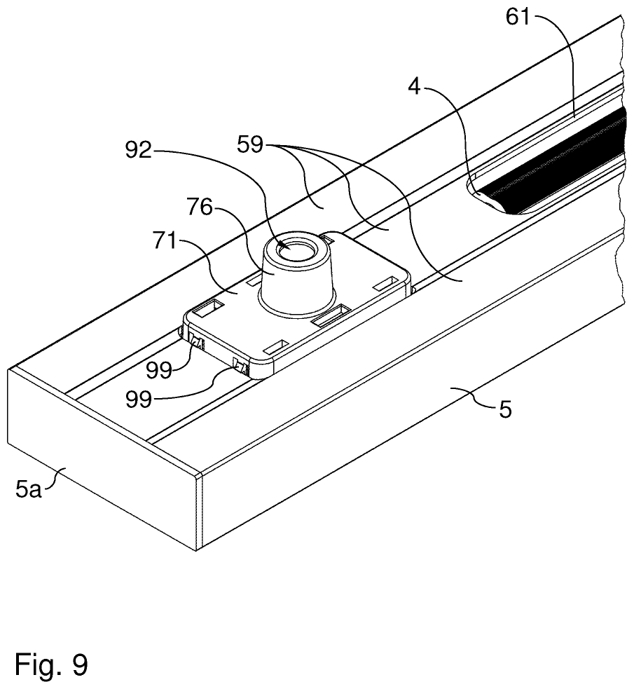

The connecting wall 59 of the outer housing 5 is provided with a substantially rectangular clearance 60, which is dimensioned in such a way that the main portion 75 of the carrier component 71 of the contacting component 7 can be inserted into the clearance 60 from the interior region 50. After insertion, the main portion 75 of the contacting component 7 substantially completely fills the clearance 60 (see for example FIGS. 7 and 9). A rim of the clearance 60 may be provided with a positioning recess 60a (see FIG. 3). A positioning projection (not shown in the drawings) may be provided on the carrier component 71, and corresponds to the positioning recess 60a and can serve to ensure that the contacting component 7 and the outer housing 5 are joined in the correct orientation relative to one another.

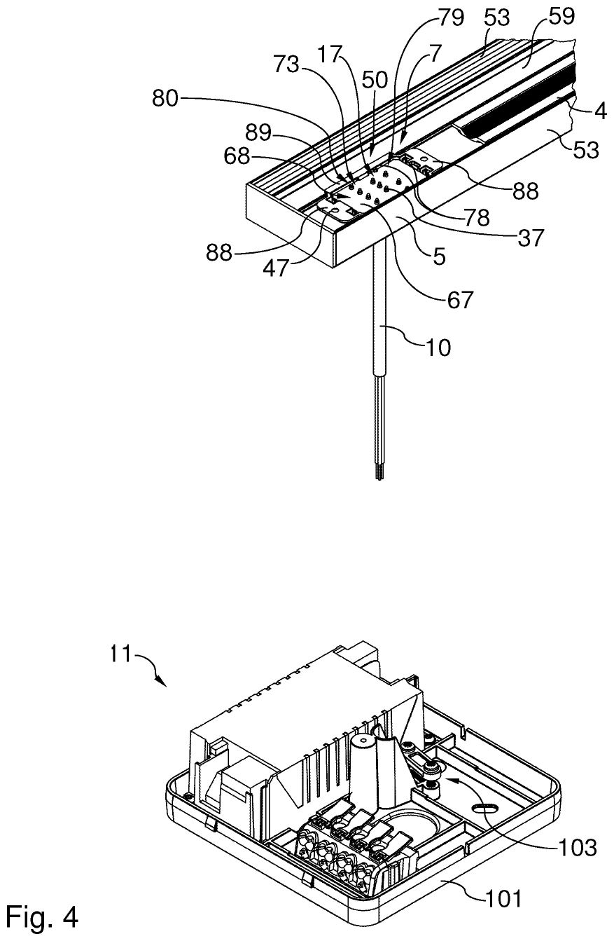

After the outer housing 5 and the contacting component 7 are joined, the outer housing 5 is positioned on the overhang 83 of the carrier component 71 (see FIG. 4). In this way, the contacting component 7 contributes to the suspended mounting of the outer housing 5 and thus of the light fixture 1. Moreover, the contacting component 7 occupies only a small amount of additional space, in a compact manner which saves space. The contacting component 7 is supported between the outer housing 5 and the light-supply circuit board 2 in portions, at least in the portions 88 and 89 of the contacting component 7 which form the overhang 83.

Approximately centrally on a main wall of the main portion 75 of the carrier component 71, which delimits the receiving region 73 and extends substantially parallel to and opposite the second main surface 69 of the contacting component circuit board 67, the main portion 75 has a shoulder 76 in which a strain relief 92 for the cable 10 is formed. The strain relief 92 may be formed with a sleeve 93, which is fixed to an end of the cable 10 connected to the contacting component 7, for example by means of a screw connection (not shown in greater detail).

A housing 101 of the operating device 11 may be fastened to the ceiling RD, for example by means of screws (not shown). Inside the housing 101, the operating device 11 also has a strain relief 103 for the cable 10, which makes it possible to set the desired length of the cable 10 between the operating device 11 and the contacting component 7 when the light fixture 1 is being mounted on the ceiling RD.

When the separate contacting component 7 is joined to the outer housing 5 by inserting the main portion 75 into the clearance 60, the contacting component 7 latches to the outer housing 5 and is thus positively and detachably held on the outer housing 5. For this purpose, the contacting component 7 has two latching means 99 on each of the mutually opposite narrow faces 97 of the housing-part-like carrier component 71, said means being formed with resiliently movable latching hooks and, so as to latch the contacting component 7 to the outer housing 5, positively engaging the connecting wall 59 from behind in portions, near a rim of the clearance 60, from an outer face of the connecting wall 59.

The inner housing 6 of the light fixture 1 carries the light-supply circuit board 2 on the side of the inner housing 6 facing the connecting wall 59. FIG. 8 shows that the light-supply circuit board 2 is fixed to the inner housing 6 by means of resiliently movable clip or snap-in elements 65 integrally moulded onto the inner housing 6, by means of a snap-in or latched connection brought about by these elements. The snap-in or latched connection brought about by the elements 65 can be released non-destructively if necessary, if appropriate with the help of a simple tool such as a flat-head screwdriver.

To connect the inner housing 6, together with the light-supply circuit board 2, to the outer housing 5, the inner housing 6 is inserted into the interior region 50. The inner housing 6 has externally, in the region of its longitudinal faces, resiliently movable latch elements 64 which are formed so as each to be releasably engaged with an engagement geometry 54 formed on the inner face of each of the side walls 53, in the first example embodiment by way of example with a longitudinal rib and a longitudinal groove arranged parallel behind it. In this way, the inner housing 6 can be mechanically coupled to the outer housing 5 by the latching so as to be detachable non-destructively, by inserting it into the interior region 50, and be positively fastened in the outer housing 5.

The non-destructively releasable connections described above, between the light-supply circuit board 2 and the inner housing 6, the inner housing 6 and the outer housing 5, and the contacting component 7 and the outer housing 5, already contribute to being able to replace individual components of the light fixture 1 if necessary. Furthermore, in the light fixture 1, a simple, easily and readily releasable electrical connection of the electrical conductors of the cable 10 to the light-supply circuit board 2 is advantageously provided, and this further simplifies the disassembly and replacement of individual components. This is described in the following.

For this purpose, the light fixture 1 has a contacting device 19, which is formed with a first contact means 13 of the light-supply circuit board 2 and a second contact means 17 of the contacting component 7. In the assembled state of the light fixture 1, the contacting device 19 establishes wireless, electrically conductive connections between the contacting component 7 and the light-supply circuit board 2, which are configured at least for transmitting an operating current for the LED devices 23 and 29, and, in some advantageous variants, for transmitting a control signals or a plurality of control signals and/or a sensor signal or a plurality of sensor signals. The control signal(s) may be routed to the light-supply circuit board 2 from the direction of the external power supply path via the contacting device 19, or the sensor signal(s) may be taken from the light-supply circuit board 2 and transmitted externally.

The first contact means 13 comprises a plurality of first contact elements 31, which are arranged distributed on a contacting area 41 in the region of the second main surface 28 of the light-supply circuit board 2 (see FIG. 8). After the light-supply circuit board 2 and the inner housing 6 are connected by latching or snapping, the second main surface 28 and thus the contacting area 41 are initially exposed.

The first contact elements 31 are each arranged substantially rigidly as a flat, planar contact region in the contacting area 41 on the main surface 28; in other words, the first contact elements 31 are not equipped with the possibility of resilient retraction. The first contact elements 31 are for example formed substantially rectangular.

The second contact means 17 comprises a plurality of second contact elements 37, each formed as a spring-loaded contact pin, the spring-loaded contact pins each having a sleeve, a spring and a piston-like contact piece, which has a contacting head and is slidably movable within the sleeve. In this way, the second contact elements 37 are each configured resiliently movable. Spring-loaded contact pins of this type are already known by the name “pogo pins”.

In one variant of the first example embodiment, the first contact elements 31 could be formed as spring-loaded contact pins and the second contact elements 37 as flat, rigid and planar contact regions. Within the group of first contact elements 31 and the group of second contact elements 37, combinations of spring-loaded contact pins and flat, planar and rigid contact regions are also conceivable in each case, it preferably always being possible for one of two contact elements mutually corresponding for contact to retract resiliently.

The second contact elements 37 of the second contact means 17 (see for example FIGS. 2, 4 and 11) are arranged distributed on the first main surface 68 of the contacting component circuit board 67. Through the open face 79 of the receiving region 73, the first main surface 68 is substantially completely exposed, in such a way that the second contact means 17 with the contact elements 37 is accessible.

During assembly of the light fixture 1, the first contact elements 31 can each be resiliently brought into electrical contact with a corresponding one of the second contact elements 37 so as to establish the wireless connections for transmitting the operating current and, if provided, the control signals and/or sensor signals. As a result of the second contact elements 37 being formed as spring-loaded contact pins in each case, resilient and therefore reliable, tolerance-compensating contact with a defined contact force is possible.

In the assembled state of the light fixture 1, the contacting component circuit board 67 and the light-supply circuit board 2 are arranged substantially mutually parallel and parallel to the connecting wall 59. In this assembled state, each of the second contact elements 37, formed as spring-loaded contact pins, holds the respective mutually corresponding ones of the contact elements 31 and 37 in electrically conductive contact by means of a spring action in the form of a spring force F (see example illustration in FIGS. 8 and 11). The contact elements 31 and 37 are arranged and dimensioned, and the distances between the light-supply circuit board 2 and the contacting component circuit board 67 are selected, in such a way that, in the assembled state, the piston-like contact pieces of the spring-loaded contact pins which form the contact elements 37 are resiliently pressed in by the light-supply circuit board 2, and a reliable wireless electrical connection with a defined spring force F is ensured. The rectangular first contact elements 31 are dimensioned, in their size in relation to the second contact elements 37, in such a way that the spring-loaded contact pins reliably meet and contact the flat contact elements 31 during the assembly process.

The cable 10 electrically conductively connects the second contact means 17 to the external operating device 11. Individual wires of the cable 10, which by way of example are shown schematically for example in FIGS. 6 and 7, are connected to the contacting component circuit board 67 via terminals 39, although this clamping has not yet taken place in FIGS. 6 and 7. Conductor tracks (not shown in greater detail) on the contacting component circuit board 67 make it possible to electrically connect each of the terminals 39 to a corresponding one of the second contact elements 37. The sleeves of the second contact elements 37 are each firmly anchored, via a socket region thereof, in the contacting component circuit board 67, where they are electrically contacted with the conductor tracks on the contacting component circuit board 67.

In this context, the electric current for operating the LED devices 23, 29 may be supplied in particular by the operating device 11. The control signals and/or sensor signals, if these are to be transmitted via the contact means 13, 17, may for example be transmitted unchanged from or to the external power supply path via the operating device 11, or alternatively undergo intermediate processing in the operating device 11.

In the first example embodiment, different numbers of pairs of contact elements 31, 37, each formed from a first contact element 31 and a corresponding second contact element 37, may be provided in different variants. For example, two, three, four, five, six, seven, eight or nine pairs of respectively mutually corresponding ones of the first and second contact elements 31, 37 may be provided. FIGS. 2-6 show the maximum possible number of nine contact elements 37 provided in the first example embodiment, for each of which there is a corresponding contact element 31 on the light-supply circuit board 2. By contrast FIG. 8 illustrates by way of example only four of these pairs of contact elements 31 and 37.

The number and arrangement of the first contact elements 31 and the corresponding second contact elements 37 may vary, in particular as a function of the type of the provided light-supply circuit board 2. The contacting component circuit board 67 may be provided with a plurality of recesses for receiving the spring-loaded contact pins or pin contacts as contact elements 37. For example, it may be provided that only the ones of the recesses required in each case are fitted with the spring-loaded contact pins and electrically connected via the terminals 39 to corresponding conductors or wires of the cable 10, for connection to the operating device 11 and via this to the external power supply path.

By way of example, in one variant, six spring-loaded contact pins or pin contacts may be provided as second contact elements 37 on the contacting component circuit board 67, and six first contact elements 31 respectively corresponding thereto may be provided in the contacting region 41, if the light-supply circuit board 2 is configured with “tunable white” capability, in other words makes it possible to set the colour temperature of the white light. Two of the pairs of contact elements 31, 37 may be provided for supplying power for the cool white light colour, two further pairs for supplying power for the warm white light colour, and two further pairs for connection to a light control system. By way of example, two pairs of contact elements 31 and 37 may be used to transmit a DALI signal, for example if the light fixture 1 is equipped with an integrated sensor and communication with this sensor is provided. Signals for transmission to and/or from one or more sensors of this type are fed to the sensor(s) from the contacting area 41 on the light-supply circuit board 2 or from the sensor(s) on the light-supply circuit board 2 to the contacting area 41. Contact is made in the contacting area 41 by means of the contacting device 19. The sensor(s) may for example be installed on the light-supply circuit board 2.

In other variants, just two, three, four or five of the spring-loaded contact pins may be provided as contact elements 37, with a corresponding number of associated contact elements 31, or more than six spring-loaded contact pins, depending on the formation of the light-supply circuit board 2, how it is equipped with the LED devices 23, 29 and optionally other electronic components, and the desired functionalities. It is also conceivable for there to be more than nine recesses for spring-loaded contact pins on the contacting component circuit board 67 and more than nine spring-loaded contact pins.

The light fixture 1 shown in FIGS. 1-11 may be assembled in different ways, depending on whether or not it is to be ensured that separating the contact elements 31 and 37 from one another requires an additional, deliberate disassembly action by a user.

A first approach does not aim for an additional disassembly action of this type. During assembly of the light fixture 1, the light-supply circuit board 2 is connected to the inner housing 6 by means of the snap-in elements 65. The end of the cable 10 for clamping to the external operating device 11 is fed through the clearance 60. The contacting component 7, which is already mechanically and electrically connected to the cable 10 at the other thereof, has its main portion 75 inserted into the clearance 60 from the interior region 50. During this joining of the contacting component 7 and the outer housing 5, the contacting component 7 latches to the connecting wall 59. In this state (see FIG. 4), the second contact means 17 is accessible from the interior region 50 of the outer housing 5. To bring the first and second contact elements 31 and 37, respectively mutually corresponding in pairs, into electrically conductive contact, in a subsequent step the inner housing 6 with the light-supply circuit board 2 arranged thereon is inserted into the interior region 50 and latched into place without tools by means of the latch elements 64. During this insertion, the mutually corresponding ones of the first and second contact elements 31, 37 are pressed against one another counter to the spring force F, causing them to be reliably contacted.

A second approach does aim for an additionally required disassembly step. Before the outer housing 5 and the contacting component 7 are joined, the contacting component 7 is additionally fixed to the second main surface 28 of the light-supply circuit board 2 at fastening positions 43 (see FIG. 8) provided adjacent to the contacting area 41 on the second main surface 28. This may for example be done using screws, which are passed through through-openings 47 in the partial overhangs 88 of the carrier component 71 and screwed into the light-supply circuit board 2 at the fastening positions 43. A pre-drilled hole may be provided at each of the fastening positions 43 for this purpose. When the contacting component 7 is fixed to the main surface 28 at the fastening positions 43, the ones of the first and second contact elements 31 and 37 respectively mutually corresponding in pairs are pressed against one another counter to the spring force F, reliably establishing electrically conductive contact between them. Before or after the contacting component 7 is fixed to the light-supply circuit board 2, said circuit board is fastened to the inner housing 6 by means of the snap-in elements 65. The end of the cable 10 for clamping to the operating device 11 is passed through the clearance 60, and then the unit with the inner housing 6, light-supply circuit board 2 and fixed contacting component 7 is inserted into the interior region 50 until the latch elements 64 engage in the engagement geometry 54. During this insertion, which again is tool-free, the contacting component 7 is simultaneously joined to the outer housing 5 by inserting the main portion 75 into the clearance 60, the contacting component 7 again being latched to the connecting wall 59.

The light fixture 1 can be disassembled easily in both cases and in particular without special tools. This is advantageous for example so as to be able to replace a light-supply circuit board 2 with a new one at the end of its service life and simultaneously for example to be able to reuse the high-quality and still undamaged outer housing 5, which is made of metal. The inner housing 6, which is latched in between the side walls 53, can easily be pulled out of the interior region 50, this being possible without tools or with careful use of a simple flat-head screwdriver. If the contacting component 7 is fixed to the light-supply circuit board 2, the latching means 99 should first be released, for example using a simple aid such as a flat-head screwdriver. Similarly, the light-supply circuit board 2 can easily be detached from the inner housing 6 by releasing the snap-in elements 65, without tools or again with the help of a simple aid such as a flat-head screwdriver.

If the contacting component 7 has been fixed at the fastening positions 43, a deliberate disassembly action is required to separate the contacting by the contacting device 19, namely releasing this fixing, for example by loosening screws.

The external operating device 11 preferably provides the rectified low voltage in such a way, in particular with regard to its level and method of supply, that the light fixture 1 downstream from the operating device 11 meets safety extra-low voltage (SELV) requirements. This increases user safety when the light fixture 1 is being disassembled. In this case, fixing the contacting component 7 to the light-supply circuit board 2 at the fastening positions 43 as described above may be unnecessary, in such a way that the first procedure described above can be used for assembly.

If one or more pairs of contact elements 31, 37 are assigned to a system which may not inherently meet SELV requirements, for example if one or more contact elements 31, 37 of this type carry a DALI signal, the contacting component 7 is preferably fixed to the light-supply circuit board 2 at the fastening positions 43, and assembly is carried out by the second procedure described above. This prevents accidental touching of contacts which do not inherently meet SELV requirements, since in this variant the user must first perform a deliberate, targeted disassembly action, namely releasing (this again being possible non-destructively) the fixing of the contacting component 7 at the fastening positions 43, for example by loosening screws. Only then can the contacting component 7 and the light-supply circuit board 2 be deliberately separated.

In the light fixture 1 shown in FIGS. 1-11, the inner housing 6 is formed as a whole in one piece as the first optical component 3, with the reflector regions 30 which are arranged in a grid pattern and each assigned to one of the LED devices 23. It will be appreciated that not all regions of the inner housing 6 have to be optically active; instead, for example, the reflector regions 30 may direct the light emitted by the LED devices 23, while other regions of the inner housing 6 may for example be for mounting in the outer housing 5 or for receiving the light-supply circuit board 2. In one variant, regions acting as lenses could be provided instead of all, one or some of the reflector regions 30.

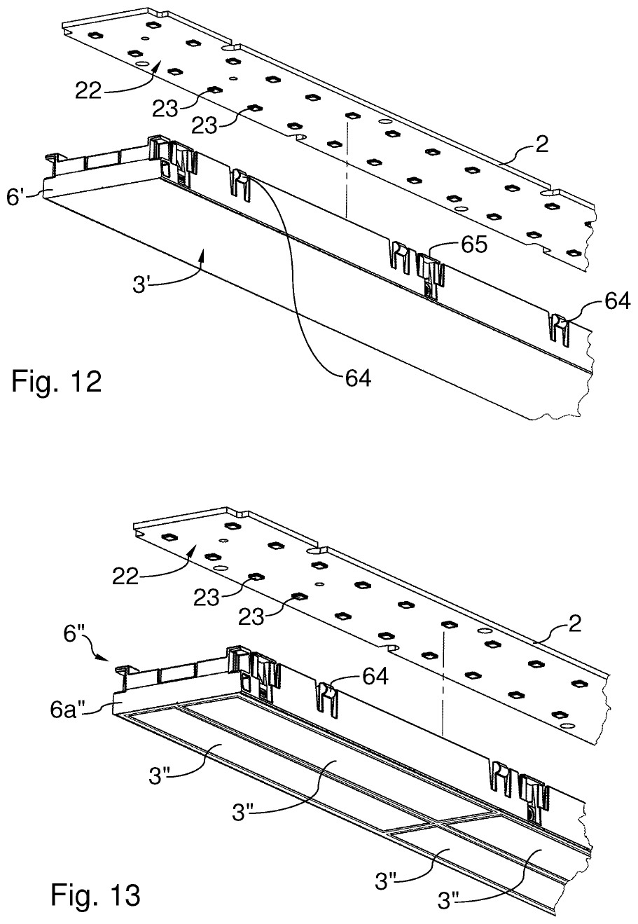

A second example embodiment is shown in FIG. 12, an inner housing 6′ being provided in the second example embodiment and again being configured as a whole as a first optical component 3'. In this case, an entire visible face of the inner housing 6′ may be effective for emitting light, in FIG. 12 in the form of an example translucent opal cover which scatters the light. A transparent cover as an optical component 3′ for directing the light is also possible. Furthermore, reference is made to the statements above regarding the first example embodiment, which are also applicable to the second example embodiment.

In a third example embodiment, merely sketched schematically in FIG. 13, it may be provided that an inner housing 6′ is formed in multiple parts with a separate first optical component 3′ or a plurality of separate first optical components 3′ and with an inner housing fastening part 6a′. The first optical component(s) 3′ may be held by the inner housing fastening part 6a′, for example being received at the rim in suitable recesses of the inner housing fastening part 6a′. The optical component(s) 3′ or some or all of them may be configured as (a) reflector(s), lens(es) or transparent or opal cover(s). In the third example embodiment, the inner housing fastening part 6a′ is for receiving and latching to the light-supply circuit board 2 and for the latched fastening in the outer housing 5. Furthermore, reference should again be made to the statements above regarding the first example embodiment, which are also applicable to the third example embodiment.

In the example embodiments described above, the inner housing 6 is made with a body of a plastics material, which in some configurations may for example be reflectively coated in regions and/or be translucent at least in regions and for example be formed lens-like, so as to form the first optical component 3, 3′ in one piece. The separately insertable optical components 3′ may be formed with a plastics material, although other configurations, for example with metal elements or glass elements as optical components 3′, are conceivable. The inner housing fastening part 6a′ of the third example embodiment is preferably also formed with a plastics material. It will be appreciated that the shapes of the optical elements 3′ in FIG. 13 are shown by way of example and that many other shapes and sizes are conceivable.

In the example embodiment described above, the second optical components 4 are formed with a translucent plastics material having desired refractive properties.

In further example embodiments, the external operating device 11 may be mounted in or behind the ceiling RD instead of being attached mounted on the ceiling. For further details on light fixtures according to further example embodiments of this type, reference is made to the statements above.

All suspended light fixtures according to the example embodiments described above and variants thereof make it easily possible to replace components such as the optical components 3, 3′, 3′ or the light-supply circuit boards (LED boards) 2, without the need to disassemble and/or replace the outer housing 5 and the operating device 11. Furthermore, if the fixing at the fastening positions 43 is not provided, the contacting component 7 can remain on the outer housing 5. This makes simple and quick maintenance of the light fixture possible in a material-saving, resource-conserving, and sustainable manner.

Although the invention has been fully described above with reference to preferred example embodiments, it is not limited to these, but rather can be modified in numerous different ways.

For example, the invention is not limited to substantially linear or elongate light fixtures, but is also applicable to suspended light fixtures of a different basic shape.

### LIST OF REFERENCE SIGNS

1 Light fixture
2 Light-supply circuit board
3, 3′, 3′ Optical component
4 Optical component
5 Outer housing
5a End cover
6, 6′, 6′ Inner housing
6a′ Inner housing fastening part
7 Contacting component
8 Rope
9 Fastening device
10 Cable
11 External operating device
13 First contact means
17 Second contact means
19 Contacting device
22 First main surface (of light-supply circuit board)
23 LED device
28 Second main surface (of light-supply circuit board)
29 LED device
30 Reflector region
31 First contact element
37 Second contact element
39 Terminal
41 Contacting area
43 Fastening position
47 Through-opening
50 Interior region (of outer housing)
53 Side wall (of outer housing)
54 Engagement geometry (of side wall)
59 Connecting wall (of outer housing)
60 Clearance
60a Positioning recess
61 Clearance
64 Latch element
65 Snap-in element
67 Contacting component circuit board
68 First main surface (of contacting component circuit board)
69 Second main surface (of contacting component circuit board)
71 Carrier component (of contacting component)
73 Receiving region
75 Main portion
76 Shoulder
78 Rim (of main portion)
79 Open face
80 Periphery (of open face)
83 Overhang
88 Partial overhang
89 Partial overhang
92 Strain relief (of contacting component)
93 Sleeve
97 Narrow face (of carrier component)
98 Long face (of carrier component)
99 Latching means
101 Housing (of operating device)
103 Strain relief (of operating device)
F Spring action
B5 Width (of outer housing)
D5 Thickness (of outer housing)
L5 Length (of outer housing)
B6 Width (of inner housing)
D6 Thickness (of inner housing)
B75 Width (of main portion)
D75 Thickness (of main portion)
L Longitudinal direction
RD Ceiling

1. Suspendable light fixture (1), comprising
a light-supply circuit board (2) equipped with LED devices (23);
an inner housing (6; 6′; 6′),
which contains at least one optical component (3; 3′; 3′) for directing light which can be emitted by the LED devices (23) or at least by a number of them, or
which is formed at least in regions as an optical component (3; 3′; 3′) for directing light which can be emitted by the LED devices (23) or at least by a number of them;
an outer housing (5) having an interior region (50), which is delimited in regions by side walls (53) of the outer housing (5) and by a connecting wall (59) of said housing connecting said side walls, and which is formed to receive the light-supply circuit board (2) and to receive the inner housing (6; 6′; 6′) at least in portions; and
a separate contacting component (7) connectable or connected to an external power supply path, at least for providing electric current for operating the LED devices (23);
wherein the contacting component (7) is joined to the outer housing (5) in the region of the connecting wall (59) and is supported at least in portions between the outer housing (5) and the light-supply circuit board (2);
wherein the light-supply circuit board (2) has a first contact means (13) with first contact elements (31) distributed over a contacting area (41) in the region of a main surface (28) of the light-supply circuit board (2), and the contacting component (7) has a second contact means (17) with second contact elements (37); and
wherein the first and second contact means (13, 17) form a contacting device (19) in such a way that respectively corresponding ones of the first and second contact elements (31, 37) can be resiliently brought into mutual electrically conductive contact during assembly of the light fixture (1), and, in the assembled state of the light fixture (1), a spring action (F) holds the respectively corresponding ones of the first and second contact elements (31, 37) in contact in each case, so as to supply the light-supply circuit board (2) with at least the electric current, the contacting device (19) establishing wireless electrically conductive connections between the contacting component (7) and the light-supply circuit board (2).

2. Suspendable light fixture according to claim 1,
wherein, after the outer housing (5) and the contacting component (7) are joined, the second contact means (17) is accessible from the interior region (50) of the outer housing (5), and wherein, to bring about the electrically conductive contact in each case, the mutually corresponding ones of the first and second contact elements (31, 37) can in each case be pressed against one another counter to the spring action (F) by inserting the inner housing (6; 6′; 6′) into the interior region (50).

3. Suspendable light fixture according to claim 1,
wherein, before the outer housing (5) and the contacting component (7) are joined, the contacting component (7) can be fixed at fastening positions (43) adjacent to the contacting area (41) on the main surface (28) of the light-supply circuit board (2), and wherein, to bring about the electrically conductive contact in each case, the mutually corresponding ones of the first and second contact elements (31, 37) can in each case be pressed against one another counter to the spring action (F) when the contacting component (7) is being fixed to the main surface (28) of the light-supply circuit board (2).

4. Suspendable light fixture according to claim 1,
wherein the first contact elements (31) are each arranged rigidly and the second contact elements (37) are each formed resiliently movable; and/or wherein all of the first and second contact elements (31, 37) of the contacting device (19) comprise spring-loaded contact pins and rigidly arranged, flat contact regions respectively corresponding thereto, and in particular the first contact elements (31) are each configured as a flat contact region in the contacting area (41) on the main surface (28) of the light-supply circuit board (2), and the second contact elements (37) are each formed as or with a spring-loaded contact pin.

5. Suspendable light fixture according to claim 1,
wherein the contacting device (19) is further formed to bring about, between the contacting component (7) and the light-supply circuit board (2), at least one wireless, electrically conductive connection for transmitting a control signal and/or at least one wireless, electrically conductive connection for transmitting a sensor signal.

6. Suspendable light fixture according to claim 1,
wherein the separate contacting component (7) has a contacting component circuit board (67), and the second contact elements (37) are distributed in the region of a main surface (68) of said circuit board and arranged so as to be respectively contactable by the first contact elements (31), and in particular wherein, in the assembled state of the light fixture (1), the light-supply circuit board (2) and the contacting component circuit board (67) are arranged substantially mutually parallel and more preferably substantially parallel to the connecting wall (59) of the outer housing (5).

7. Suspendable light fixture according to claim 6,
wherein the contacting component (7) has a housing-part-like carrier component (71) with a receiving region (73) for the contacting component circuit board (67), the contacting component circuit board (67) being received in the receiving region (73) and the receiving region (73) having an open face (79) through which the second contact means (17) is accessible.

8. Suspendable light fixture according to claim 7,
wherein the housing-part-like carrier component (71) has a box-like main portion (75) within which the receiving region (73) with the open face (79) is formed, the housing-part-like carrier component (71) being formed with an, in particular plate-like, overhang (83) at a rim (78) of the main portion (75), said rim delimiting the open face (79) of the receiving region (73), and the outer housing (5) resting on the overhang (83) of the housing-part-like carrier component (71) after the outer housing (5) and the contacting component (7) are joined, and the overhang (83) preferably being formed substantially surrounding the open face (79) along its periphery (80) and/or with a plurality of partial overhangs (88, 89) provided along its periphery (80).

9. Suspendable light fixture according to claim 7,
wherein the housing-part-like carrier component (71) is formed flat at least in portions, and/or the main portion (75) is formed with a substantially cuboid outer shape.

10. Suspendable light fixture according to claim 8,
wherein the housing-part-like carrier component (71) is formed flat at least in portions, and/or the main portion (75) is formed with a substantially cuboid outer shape.

11. Suspendable light fixture according to claim 1,
wherein the connecting wall (59) of the outer housing (5) is provided with a clearance (60), which is in particular substantially rectangular, the contacting component (7), to join it to the outer housing (5), being insertable into the clearance (60) from the interior region (50) in portions, and preferably substantially filling the clearance (60) after the joining.

12. Suspendable light fixture according to claim 1,
wherein the contacting component (7) can be latched to the outer housing (5) when being joined thereto and is thus positively, and preferably detachably, held on the outer housing (5) in the assembled state of the light fixture (1), and in particular wherein the contacting component (7) is provided with latching means (99) for latching to the outer housing (5), which are configured to engage the connecting wall (59) positively in portions from behind.

13. Suspendable light fixture according to claim 1,
wherein the contacting component (7) is configured as part of a suspension device for the light fixture (1) and is configured to absorb and transmit mechanical loads at least from part of the weight of the light fixture (1).

14. Suspendable light fixture according to claim 1,
wherein an external operating device (11) is provided, and wherein the contacting component (7) is connected to the external power supply path via the external operating device (11), a cable (10) being provided which electrically conductively connects the second contact means (17) to the external operating device (11); and in particular wherein the external operating device (11) is formed as an electronic ballast and set up to convert a mains voltage supplied via the external power supply path into a rectified low voltage.

15. Suspendable light fixture according to claim 1,
wherein the inner housing (6; 6′; 6′) carries the light-supply circuit board (2).

16. Suspendable light fixture according to claim 1,
wherein the inner housing (6; 6′; 6′) can be mechanically coupled to the outer housing (5), preferably by latching, by inserting it into the interior region (50) of the outer housing (5), and in particular wherein the resulting mechanical fastening of the inner housing (6; 6′; 6′) in the outer housing (5) is releasable non-destructively.

17. Suspendable light fixture according to claim 1,
wherein the optical component (3; 3′; 3′) is a first optical component for providing direct illumination, and the light fixture (1) further has at least one second optical component (4) for providing indirect illumination, the light-supply circuit board (2) being equipped with LED devices (23, 29) on both of its main surfaces (22, 28), and in particular wherein the outer housing (5) has at least one additional clearance (61) so as to allow light emission via the second optical component (4).

18. Suspendable light fixture according to claim 1,
wherein the light fixture (1) is formed elongate and/or linear and in particular the ratio of the length (L5) of the outer housing (5) to the width (B5) of the outer housing (5) is in a range of approximately 15 to approximately 75, preferably in a range of approximately 20 to approximately 40; and/or wherein
the outer housing (5) is formed with a linear profile and in particular the profile has an inverted U-shaped cross section, the interior region (50) being formed between the legs of the U.

19. Suspendable light fixture according to claim 1,
wherein the outer housing (5) is made of or with a metal material, in particular of or with aluminium or an aluminium alloy.
